(19) United States
(12) Patent Application Publication
(10) Pub. No.: US 2019/0287505 A1
(43) Pub. Date: Sep. 19, 2019

(54) APPARATUS FOR DETECTING MUSICAL NOTE OF INSTRUMENT WHICH GENERATES SOUND BASED ON SENSOR

(71) Applicant: JAMEASY INC., Gyeonggi-do (KR)

(72) Inventors: Dae Young JEON, Seoul (KR); Yeon Su KIM, Gyeonggi-do (KR); Yeong Min KIM, Gyeonggi-do (KR); Kyung Seok OH, Seoul (KR)

(21) Appl. No.: 16/116,395

(22) Filed: Aug. 29, 2018

(30) Foreign Application Priority Data
Mar. 16, 2018 (KR) 10-2018-0031015

(51) Int. Cl. G10H 1/44

(52) U.S. Cl. CPC G10H 1/44; G10H 2220/525; G10H 2240/251

(57) ABSTRACT

There is provided an apparatus for detecting a musical note of an instrument comprising a sensor unit including a sensor configured to sense a vibration of the instrument and a control unit configured to identify a component of the musical note based on a frequency of the vibration recognized by the sensor unit, wherein the sensor unit is connected to a port of a microprocessor of the control unit through a first route to transfer the recognized vibration, and wherein the sensor unit is selectively connected to a port of the microprocessor through a second route different from the first route to output a sound based on a signal supplied from the microprocessor.

This application claims priority from Korean Patent Application No. 10-2018-0031015, filed on Mar. 16, 2018, in the Korean Intellectual Property Office, the disclosure of which is incorporated herein by reference in its entirety.

### BACKGROUND

### 1. Field of the Disclosure

The present disclosure relates to an apparatus for detecting a musical note of an instrument.

### 2. Description of the Related Art

A conventional instrument tuning apparatus has an advantage of being attached to an instrument to be capable of measuring an accurate musical note of the instrument, but has limitations in providing various user interfaces (UIs) in terms of power consumption and portability of the apparatus.

Recently, applications for tuning instruments using mobile apparatuses have been developed. Instrument tuning using the mobile apparatuses has an advantage of being applied to various instruments and providing various and convenient UIs. However, it is difficult to attach the mobile apparatus to the instrument, and thus it is difficult to measure an accurate musical note of the instrument. Accordingly, it is necessary to study a tuning assistant apparatus linked to the mobile apparatus to be capable of measuring the accurate musical note of the instrument.

### SUMMARY

Aspects of the present disclosure provide an apparatus attached to an instrument to measure a component of a musical note corresponding to a vibration having a frequency at a magnitude greater than or equal to a predetermined magnitude. Further, aspects of the present disclosure also provide a method of generating sounds based on a piezo sensor without including a separate sound component.

However, technical problems which will be solved by the embodiment are not limited to the above-described technical problems, and may include other technical problems.

According to an exemplary embodiment of the present disclosure, there is provided an apparatus for detecting a musical note of an instrument. The apparatus comprises a sensor unit including a sensor configured to sense a vibration of the instrument and a control unit configured to identify a component of the musical note based on a frequency of the vibration recognized by the sensor unit, wherein the sensor unit is connected to a port of a microprocessor of the control unit through a first route to transfer the recognized vibration, and wherein the sensor unit is selectively connected to a port of the microprocessor through a second route different from the first route to output a sound based on a signal supplied from the microprocessor.

According to another exemplary embodiment of the present disclosure, there is provided a method of detecting a musical note of an instrument through an apparatus for detecting including a piezo sensor and a microprocessor. The method comprises sensing a vibration of an instrument based on the piezo sensor, transferring a signal sensed by the piezo sensor via a first route through a port of the microprocessor to identify a component of the musical note based on a frequency of the vibration and outputting a sound from the piezo sensor by selectively connecting the piezo sensor and the microprocessor via a second route which is different from the first route and receiving the signal from the microprocessor through the port of the microprocessor.

According to another exemplary embodiment of the present disclosure, there is provided a non-transitory computer-readable storage medium that stores a computer program which, when executed by a computing apparatus including a piezo sensor and a microprocessor, causes the computing apparatus to perform sensing a vibration of an instrument based on the piezo sensor, transferring a signal sensed by the piezo sensor via a first route through a port of the microprocessor to identify a component of the musical note based on a frequency of the vibration outputting a sound from the piezo sensor by selectively connecting the piezo sensor and the microprocessor via a second route which is different from the first route and receiving the signal from the microprocessor through the port of the microprocessor.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a view for describing an instrument tuning system according to an embodiment of the present disclosure;

FIG. 2 is a block diagram illustrating a configuration of a tuning assistant apparatus according to the embodiment of the present disclosure;

FIG. 3 is a block diagram illustrating a configuration of a sensor unit according to the embodiment of the present disclosure in more detail;

FIG. 4 is a block diagram illustrating a configuration of a according to the embodiment of the present disclosure in more detail;

FIG. 5 is another block diagram illustrating the configuration of the control unit according to the embodiment of the present disclosure in more detail;

FIG. 6 is a flow chart illustrating a method in which the tuning assistant apparatus according to the embodiment of the present disclosure detects a musical note of an instrument; and

FIGS. 7 and 8 are configuration views of a circuit structure between the sensor unit and the control unit (a microprocessor) of the tuning assistant apparatus according to the embodiment of the present disclosure.

### DETAILED DESCRIPTION OF THE EMBODIMENTS

Hereinafter, exemplary embodiments of the present disclosure will be described in detail with reference to the accompanying drawings which may allow one of ordinary skill in the art to easily perform the present disclosure. The present disclosure may be implemented in various forms and is not limited to the following embodiments. Further, components not related to the description are omitted in the drawings to clearly describe the present disclosure, and similar reference symbols are used for similar components in the description.

In the whole description, a case in which one part is “connected to” another part includes not only a case of “direct connection”, but also a case of “electrical connection”. Further, a case in which the one part “includes” one component means not precluding other components and further including other components unless specifically stated otherwise and has to be understood as not precluding the presence or addition of one or more other features, integers, steps, operations, elements, components, and/or groups thereof.

In the present description, a “part” includes a unit implemented by hardware, a unit implemented by software, and a unit implemented using both of the above. Further, one unit may be implemented using at least two types of hardware, and at least two units may be implemented by one type of hardware.

In the present description, some operations or functions performed by a terminal or an apparatus may be performed by a server connected to the terminal or apparatus. Like the above, some operations or functions disclosed to be performed by the server may be performed by the terminal or apparatus connected by the server.

Hereinafter, an embodiment of the present disclosure will be described in detail with reference to the accompanying drawings.

FIG. 1 is a view for describing an instrument tuning system according to an embodiment of the present disclosure.

Referring to FIG. 1, an instrument tuning system 10 includes a tuning assistant apparatus 11 and a mobile apparatus 12.

According to the embodiment, the tuning assistant apparatus 11 may be attached to an instrument to sense a vibration generated from the instrument, and distinguish a component of a musical note corresponding to the sensed vibration. In this case, the component of the musical note may include at least one among musical scale information of a played note, note name information, and note length information. The tuning assistant apparatus 11 may transfer the distinguished component of the musical note to the mobile apparatus 12.

However, the tuning assistant apparatus 11 may sense a vibration according to movement of the instrument, and movement of a user of the instrument. Accordingly, the tuning assistant apparatus 11 according to the disclosed embodiment omits an operation for distinguishing the component of the musical note for a vibration departing from scope of the musical note by comparing the sensed vibration with a threshold value. Accordingly, the tuning assistant apparatus 11 may minimize power consumption therein.

Meanwhile, the tuning assistant apparatus 11 may refer to an apparatus for detecting a musical note. That is, the tuning assistant apparatus 11 operates as a tuning assistant apparatus when desiring to tune the instrument, and operates as the apparatus for detecting a musical note in real time when the user plays a particular piece of music with the instrument after tuning is completed.

According to the embodiment, the mobile apparatus 12 may receive the component of the musical note transferred from the tuning assistant apparatus 11 to display the component of the musical note on a screen thereof. Further, the mobile apparatus 12 may use the musical note received from the tuning assistant apparatus 11 to execute an instrument tuning application. For example, the mobile apparatus 12 may provide a tuning method of the instrument according to a result of comparison between the component of the musical note received from the tuning assistant apparatus 11 and a component of a target sound after leading the user to play the target sound through the instrument tuning application. However, the mobile apparatus 12 is not limited to the above, and may use the component of the musical note received from the tuning assistant apparatus 11 to execute a game application.

Each of the components of the tuning system 10 in FIG. 1 is generally connected through a network. Here, the network includes, for example, Wi-Fi, Bluetooth, the Internet, a local area network (LAN), a wireless local area network (wireless LAN), a wide area network (WAN), a personal area network (PAN), 3G, 4G, LTE, and the like, but is not limited thereto.

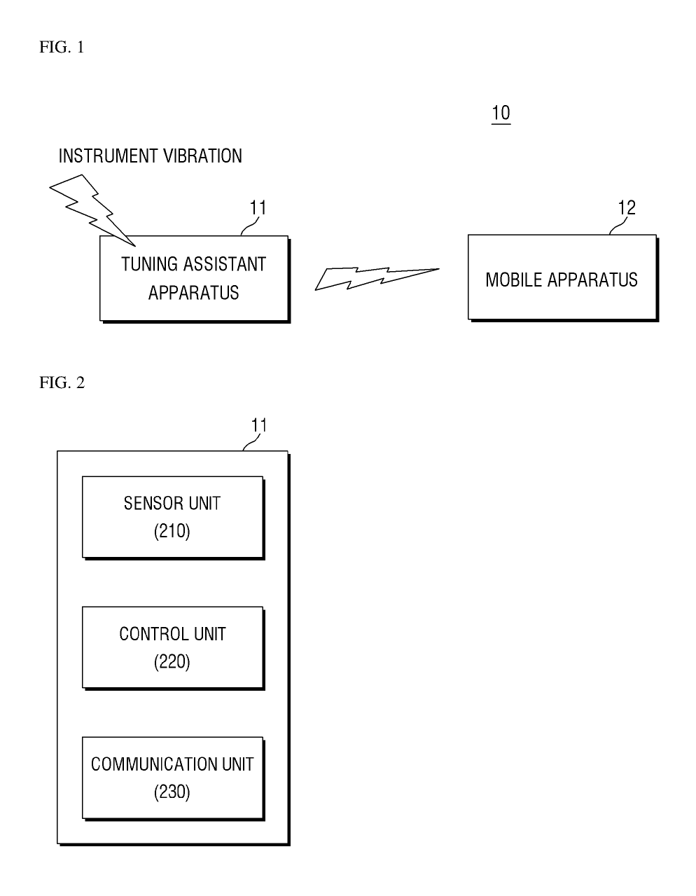

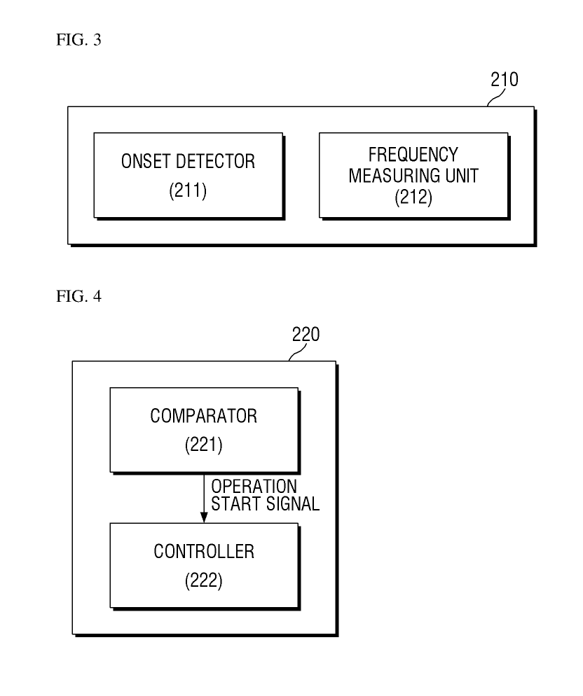

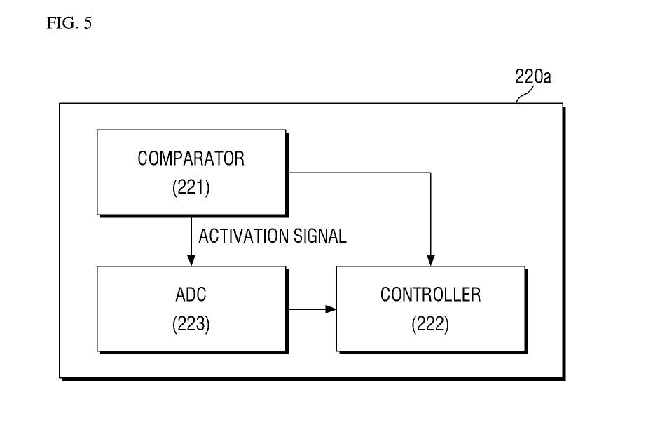

FIG. 2 is a block diagram illustrating a configuration of a tuning assistant apparatus according to the embodiment of the present disclosure. Further, FIG. 3 is a block diagram illustrating a configuration of a sensor unit according to the embodiment of the present disclosure in more detail, and FIGS. 4 and 5 are block diagrams illustrating a configuration of a control unit according to the embodiment of the present disclosure in more detail. Hereinafter, the configuration of the tuning assistant apparatus will be described in detail with reference to FIGS. 2 to 5.

Referring to FIG. 2, the tuning assistant apparatus 11 attached to the instrument includes a sensor unit 210, a control unit 220, and a communication unit 230.

The sensor unit 210 may sense the vibration generated from the instrument. The sensor unit 210 may be implemented as a piezo effect type piezoelectric sensor (alternatively, piezoelectric element).

Specifically, as shown in FIG. 3, the sensor unit 210 may include an onset detector 211 configured to sense a starting point of the vibration, and a frequency measuring unit 212 configured to sense a pitch of the vibration to measure a frequency of the vibration. The measured frequency may be provided to the control unit 220. Further, the frequency measuring unit 212 may provide a vibration amplified according to the pitch of the vibration to the control unit 220. In this case, the sensor unit 210 may further include an amplifier (not shown).

Meanwhile, according to the embodiment, the sensor unit 210 may use the piezoelectric sensor to output a predetermined note by control of the control unit 220. For example, the sensor unit 210 may output the predetermined note when at least one of a turn-on operation, a turn-off operation, a communication connection operation to a mobile apparatus is performed by the control of the control unit 220. In this case, the predetermined note may vary according to operation.

Referring to FIG. 2 again, the control unit 220 distinguishes a component of the musical note corresponding to the vibration based on a frequency of the vibration provided from the sensor unit 210 (and/or the amplified vibration). In this case, the control unit 220 may distinguish a component of the musical note only for a vibration of which a magnitude is greater than or equal to (alternatively, greater than) a threshold value to minimize the power consumption in the tuning assistant apparatus 11.

Specifically, as shown in FIG. 4, the control unit 220 may include a comparator 221 configured to compare the magnitude of the vibration provided from the sensor unit 210 (alternatively, the amplified vibration) with the threshold value, and a controller 222 configured to distinguish a component of a musical note corresponding to the vibration which is greater than or equal to (alternatively, greater than) the threshold value based on a result of comparison by the comparator 221. Here, the threshold value may be an average value of magnitudes of vibrations of the musical notes which were distinguished before. Alternatively, the threshold value may be determined by at least one between a minimum vibration magnitude and a maximum vibration magnitude generable from the instrument. Alternatively, the threshold value may be set in a manufacturing process of the tuning assistant apparatus 11 or by the user.

For example, when the magnitude of the vibration is greater than or equal to (alternatively, greater than) the threshold value, the comparator 221 may provide a predetermined operation start signal to the controller 222 so that the controller may operate. However, when the magnitude of the vibration is smaller than (alternatively, smaller than or equal to) the threshold value, the comparator 221 may not provide the predetermined operation start signal to the controller 222 so that the controller 222 may not operate.

The controller 222 may control overall operations of the tuning assistant apparatus 11, and may include at least one processor (not shown) and/or a microprocessor (not shown) configured to distinguish the component of the musical note corresponding to the vibration. Here, the component of the musical note may include at least one among musical scale information of a played note, note name information, and note length information.

The controller 222 may determine the component of the musical note matched to the frequency of the vibration based on musical scale information, note name information, and the like which are prestored.

Further, referring to FIG. 5, a control unit 220a may further include an analog-digital converter (ADC) 223 in addition to the above-described comparator 221 and controller 222.

The ADC 223 may be activated by an activation signal from the comparator 221, and may generate a digital signal corresponding to the vibration. Further, the ADC 223 may be connected to the controller 222 to provide the generated digital signal to the controller 222.

Specifically, when the magnitude of the vibration is greater than or equal to (alternatively, greater than) the threshold value, the comparator 221 may provide the activation signal to the ADC 223. The ADC 223 may operate in a deactivated state even when the tuning assistant apparatus 11 is turned on, and may be converted to an activated state when the activation signal is provided from the comparator 221. Here, the deactivated state may be a state which receives minimum power from a power source, and may be referred to as a sleep mode, a low power mode, or a standby mode according to the embodiment.

The ADC 223 may be converted to the deactivated state again after providing the digital signal corresponding to the vibration to the controller 222.

Meanwhile, although the ADC 223 is described to be converted to the activated state by the comparator 221 in FIG. 5, it is not limited thereto. According to the embodiment, the comparator 221 may provide the activation signal to the ADC 223 and controller 222 according to a result of comparison between the magnitude of the vibration and the threshold value. In this case, the controller 222 may operate in the deactivated state after the tuning assistant apparatus 11 is turned on, and may be converted to the activated state by the activation signal. Here, the activation signal may be the same as the above-described operation start signal, and may also be a separate signal.

Referring to FIG. 2 again, the communication unit 230 may include at least one element configured to allow the tuning assistant apparatus 11 to communicate with the mobile apparatus 12 and other apparatuses. For example, the communication unit 230 may include a Bluetooth module, a Bluetooth low energy (BLE) module, a near field communication (NFC) module, a Wi-Fi (WLAN) module, a Zigbee module, an infrared data association (IRDA) module, a Wi-Fi direct (WFD) module, an ultra wideband (UWB) module, an Ant+ module, and the like, but is not limited thereto.

Meanwhile, not all of elements shown in FIGS. 2 to 5 are essential elements of the tuning assistant apparatus 11. The tuning assistant apparatus 11 may be implemented by more elements than the elements shown in FIGS. 2 to 5, and may also be implemented by fewer elements than the elements shown in FIGS. 2 to 5. For example, the tuning assistant apparatus 11 may further include a computer readable medium including a sequence of at least one instruction to sense the musical note of the instrument and distinguish the component of the musical note.

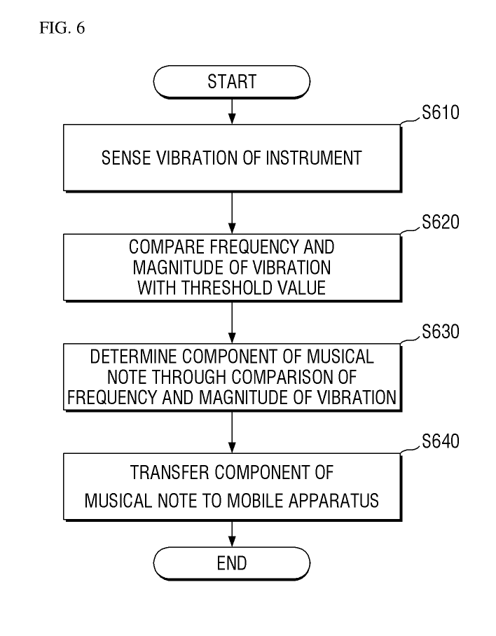

Hereinafter, FIG. 6 is a flow chart illustrating a method in which the tuning assistant apparatus according to the embodiment of the present disclosure detects a musical note of an instrument. In FIG. 6, a method of operating the tuning assistant apparatus 11 relates to the embodiment which is described in the above-described FIGS. 1 to 5. Accordingly, the above-described descriptions described in FIGS. 1 to 5 may be applied to the method of operating the tuning assistant apparatus 11 in FIG. 6 even when being omitted below.

First, the tuning assistant apparatus 11 senses the vibration of the instrument (S610). The tuning assistant apparatus 11 may use a piezoelectric sensor based on a piezo effect method to sense the vibration of the instrument. The tuning assistant apparatus 11 may sense a starting point of the vibration, and sense the pitch of the vibration to measure the frequency of the vibration

Further, the tuning assistant apparatus 11 compares the magnitude of the vibration with a threshold value based on the measured frequency (S620). More accurately, the magnitude of each of the frequency and the vibration is compared with the threshold value. Preferably, a correlation period of waveform data may be compared with a preregistered threshold value. Here, the threshold value may be data based on the average value of the magnitudes of the vibrations of the musical notes which were distinguished before. Alternatively, the threshold value may be determined by at least one between the minimum vibration magnitude and the maximum vibration magnitude generable from the instrument. Alternatively, the threshold value may be set in a manufacturing process of the tuning assistant apparatus 11 or by a user.

The tuning assistant apparatus 11 may distinguish a component of the musical note distinguished through comparison between the frequency and the magnitude of the vibration (S630). The tuning assistant apparatus 11 may distinguish the component of the musical note matched to the vibration based on prestored musical scale information, note name information, and the like. Here, the component of the musical note may include at least one among musical scale information of a played note, note name information, and note length information.

Further, when the magnitude of the vibration is greater than or equal to (alternatively, greater than) the threshold value, the tuning assistant apparatus 11 may convert at least one of the elements of the tuning assistant apparatus 11 from a deactivated state to an activated state. For example, the tuning assistant apparatus 11 may generate a digital signal corresponding to the vibration when at least one element (for example, the ADC 223 in FIG. 5) is activated, and may distinguish a component of the musical note corresponding to the digital signal. Accordingly, the tuning assistant apparatus 11 may reduce an amount of the power consumed in the tuning assistant apparatus 11.

Further, the tuning assistant apparatus 11 transfers the component of the distinguished musical note to the mobile apparatus 12 (S640). The tuning assistant apparatus 11 may have Bluetooth communication with, for example, the mobile apparatus 12. However, the present disclosure is not limited thereto, and the tuning assistant apparatus 11 may communicate with the mobile apparatus 12 through local area communication such as tuning BLE communication, NFC communication, Zigbee communication, WLAN communication, infrared communication, Wi-Fi communication, or the like.

Meanwhile, in the above description, the operations S610 to S640 may be divided into additional operations or combined to fewer operations according to the embodiment of the present disclosure. Further, some operations may be omitted according to necessity, and an order of the operations may be changed.

Further, according to the embodiment, the tuning assistant apparatus 11 may use the above-described piezoelectric sensor (the piezo sensor) to output a predetermined note. For example, the tuning assistant apparatus 11 may output the predetermined note when at least one of a turn-on operation, a turn-off operation, a communication connection operation to a mobile apparatus, thereof is performed. In this case, the predetermined note may vary according to operation of the tuning assistant apparatus 11. Accordingly, the tuning assistant apparatus 11 may use the piezoelectric sensor to output the predetermined note without including a separate output apparatus.

A method of outputting a sound corresponding to the predetermined note not to a sound output apparatus but to a piezoelectric sensor configured to perform only vibration sensing will be described below.

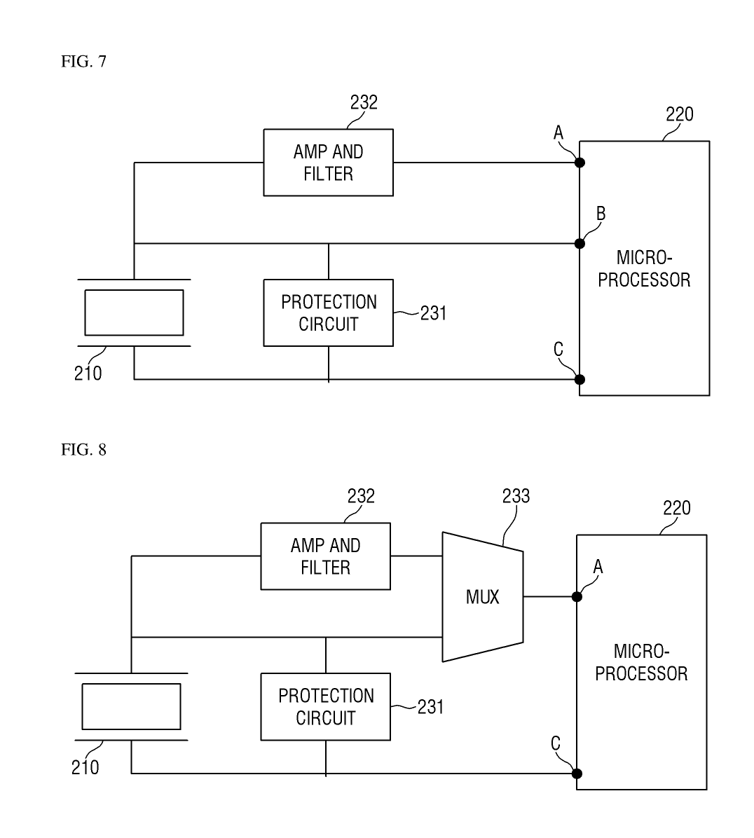

Referring to FIG. 7, a circuit structure of the control unit including the sensor unit 210, including the piezoelectric sensor, and the microprocessor 220 may be identified. The microprocessor 220 may include all of the above-described comparator, ADC, and controller.

The sensor unit 210 is connected to the microprocessor 220 through a first port A, a second port B, and a third port C of the microprocessor 220. The first port A and the sensor unit 210 are connected through an amplifier and filter 232. Further, the sensor unit 210 is connected to the second port B and the third port C, and in this case, a protection circuit 231 is disposed between the second port B and the third port C, and has a disposition structure which is electrically parallel with the sensor unit 210. The protection circuit is a configuration added to prevent generation of a high voltage in the piezo sensor due to a physical shock like an electric lighter.

In the case of a vibration recognition mode, the connection between the second port B and the sensor unit 210 is blocked, and a signal sensed by the sensor unit 210 is transferred to the microprocessor 220 through the first port A. Although not shown in the drawings, since a switch is installed between the second port B and the sensor unit 210, in the case of the vibration recognition mode, a state in which a wire connection is disconnected may be selectively formed. Accordingly, a case in which the signal flows to the second port B and thus signal loss occurs may be prevented. Further, a signal transferred to the first port A may be converted to a digital signal through an analog-digital converter (ADC) in the microprocessor 220, and the component of the musical note may be detected based on the digital signal. In this case, the sensor unit 210 is connected to the first port A and the third port C, and the third port C may serve as a ground.

In the case of a sound output mode, since connection between the first port A and the sensor unit 210 is blocked, and signals generated at the second and third ports B and C are applied to the sensor unit 210, a sound of a particular frequency (the predetermined note) may be generated in the sensor unit 210. Although not shown in the drawings, since a switch is installed between the first port A and the sensor unit 210, in the case of the sound output mode, the state in which a wire connection is disconnected may be selectively formed. Accordingly, occurrence of unnecessary power loss through the first port A may be prevented.

In this case, although the sound may be generated through the sensor unit 210 by generating the signal at the second port B and grounding the third port C, in this case, an amount in which the piezo sensor is deformed is small, and thus a sound may be generated to be small. To overcome this, the third port C may not be a ground and generate a signal having a phase opposite to that of the second port B (a phase difference of) 180° to provide an effect the same as a case in which a voltage difference between the signals generated at the second port B and the third port C is doubly applied. Accordingly, a louder sound may be generated.

In the above-described process, the third port C performs different roles in the vibration recognition mode and the sound output mode. That is, it serves as a ground in the vibration recognition mode, and serves as a phase reversal signal output in the sound output mode.

Meanwhile, the signals generated at the second and third ports B and C and applied to the sensor unit 210 may be pulse width modulation (PWM) signals.

Through the above-described processes, a state of a apparatus or information of a key which has to be set may be provided to the user as a sound by just the piezo sensor. Further, since a separate sound output apparatus is not required, costs may be reduced. In addition, whether a state of the sensor is normal may be checked through a sound generated in the piezo sensor during production.

Meanwhile, as an additional embodiment, as shown in FIG. 8, only two ports A and C may be provided, a vibration recognition mode and a sound output mode of a sensor unit 210 may be implemented through a MUX. That is, an MUX 233 may be disposed between the first port A, an amplifier and filter 232, and a protection circuit 231. Only one terminal between two terminals is implemented in the MUX 233 to be selectively connectable, and in the case of the vibration recognition mode, the MUX 233 may allow the first port A and the terminal of the amplifier and filter 232 to be connected to each other (that is, the sensor unit 210 and the first port A are connected via a first route), and in the case of the sound output mode, the MUX 233 may allow terminals of the sensor unit and the protection circuit, and the first port A to be connected to each other. (that is, the sensor unit 210 and the first port A are connected via a second route)

Further, as an additional embodiment, in the sound output mode, a phase of a signal of a third port C may not be implemented to be reversed based on a signal phase of another port, the third port C may be grounded, and a voltage generated at another port may be generated as a very large predetermined voltage.

In addition, as an additional embodiment, in the sound output mode, a voltage applied to the sensor unit may be generated based on an induced electromotive force through an inductor.

The present disclosure may be implemented into a recording medium form including instructions executable by a computer such as a program module executed by the computer. The computer readable medium may be any available medium accessible by the computer, and includes all of volatile and nonvolatile media, and separable and nonseparable media. Further, the computer readable medium may include all computer storage media. The computer storage media includes all of computer readable instructions, a data structure, the volatile and nonvolatile media, and the separable and nonseparable media implemented as a method or a technology for storing information such as a program module, other data, or the like.

According to one of the above-described technical solutions, a method and apparatus for minimizing an amount of power consumption and detecting a musical note of an instrument can be provided.

Further, since an inner sound output apparatus does not have to be used by differently configuring a circuit structure and generating sounds with only a piezo sensor, component costs can be reduced, and a state of the sensor can be checked based on sounds generated from the piezo sensor during production.

The above-described descriptions of the present disclosure are exemplary, and those skilled in the art of the present disclosure may understand that the present disclosure may be embodied in other specific forms without changing the technical spirit or essential characteristics. Accordingly, the above described embodiments should be understood to be exemplary and not limiting. For example, each component described as a single entity may be distributed and implemented, and components described as being dispersed may be implemented in an integrated form.

The scope of the present disclosure is shown by the claims rather than the detailed description, and all of variations or different forms derived from the means, scope, and equivalents of the claims should be interpreted to be included in the scope of the present disclosure.

What is claimed is:

1. An apparatus for detecting a musical note of an instrument, comprising:
a sensor unit including a sensor configured to sense a vibration of the instrument; and
a control unit configured to identify a component of the musical note based on a frequency of the vibration recognized by the sensor unit,
wherein the sensor unit is connected to a port of a microprocessor of the control unit through a first route to transfer the recognized vibration, and
wherein the sensor unit is selectively connected to a port of the microprocessor through a second route different from the first route to output a sound based on a signal supplied from the microprocessor.

2. The apparatus for detecting a musical note of an instrument of claim 1, wherein the sensor unit generates a sound of a particular frequency based on the signal supplied from the microprocessor.

3. The apparatus for detecting a musical note of an instrument of claim 1, wherein the sensor unit generates the sound based on a voltage greater than a voltage of the signal applied from the port of the microprocessor.

4. The apparatus for detecting a musical note of an instrument of claim 3, wherein:
the sensor unit is connected through two ports of the microprocessor; and
phases of signals generated at the two ports are opposite to each other.

5. The apparatus for detecting a musical note of an instrument of claim 1, wherein:
the microprocessor is connected to the sensor unit through a first port and a third port;
a connection route between the sensor unit and the first port includes the first route for vibration recognition, and the second route for sound output; and
one of the first and the second routes is selectively connected to the microprocessor and the sensor unit through a MUX.

6. The apparatus for detecting a musical note of an instrument of claim 1, wherein:
the sensor unit is connected to a first port, a second port, and a third port of the microprocessor;
in a vibration recognition mode, a connection between the second port and the sensor unit is blocked, and a signal recognized by the sensor unit is transferred to the microprocessor through the first port; and
in a sound output mode, a connection between the first port and the sensor unit is blocked, signals generated at the second and the third ports are applied to the sensor unit, and a sound of a particular frequency is generated at the sensor unit.

7. The apparatus for detecting a musical note of an instrument of claim 6, wherein:
an amplifier and filter is installed between the first port and the sensor unit;
the signal transferred to the first port is converted to a digital signal through an analog-digital converter (ADC) in the microprocessor; and
a musical note component is detected based on the digital signal.

8. The apparatus for detecting a musical note of an instrument of claim 6, wherein the third port performs different roles in the vibration recognition mode and the sound output mode.

9. The apparatus for detecting a musical note of an instrument of claim 8, wherein the third port serves as a ground in the vibration recognition mode, and serves as a phase reversal signal output in the sound output mode.

10. The apparatus for detecting a musical note of an instrument of claim 6, further comprising a protection circuit connected in parallel to the sensor unit between the second and the third ports.

11. The apparatus for detecting a musical note of an instrument of claim 6, wherein the signals generated at the second and the third ports includes a pulse width modulation (PWM) signal.

12. The apparatus for detecting a musical note of an instrument of claim 1, wherein the sensor unit includes a piezo sensor.

13. A method of detecting a musical note of an instrument through an apparatus for detecting including a piezo sensor and a microprocessor, the method comprising:
sensing a vibration of an instrument based on the piezo sensor;
transferring a signal sensed by the piezo sensor via a first route through a port of the microprocessor to identify a component of the musical note based on a frequency of the vibration; and
outputting a sound from the piezo sensor by selectively connecting the piezo sensor and the microprocessor via a second route which is different from the first route and receiving the signal from the microprocessor through the port of the microprocessor.

14. A non-transitory computer-readable storage medium that stores a computer program which, when executed by a computing apparatus including a piezo sensor and a microprocessor, causes the computing apparatus to perform:
sensing a vibration of an instrument based on the piezo sensor;
transferring a signal sensed by the piezo sensor via a first route through a port of the microprocessor to identify a component of the musical note based on a frequency of the vibration; and
outputting a sound from the piezo sensor by selectively connecting the piezo sensor and the microprocessor via a second route which is different from the first route and receiving the signal from the microprocessor through the port of the microprocessor.
